(19) United States
(12) Patent Application Publication
(10) Pub. No.: US 2002/0120552 A1
(43) Pub. Date: Aug. 29, 2002

(54) System and method for utilizing dynamic auction parameters

(76) Inventors: William Grey, Millwood, NY (US); Clifford A. Pickover, Yorktown Heights, NY (US); Paul A. Moskowitz, Yorktown Heights, NY (US); Stephen J. Boies, Mahopac, NY (US)

Correspondence Address: BUCKLEY, MASCHOFF, TALWALKAR, & ALLISON, 5 ELM STREET, NEW CANAAN, CT, 06840, US

(21) Appl. No.: 09/794,875

(22) Filed: Feb. 27, 2001

(51) Int. Cl. G06F 17/60

(52) U.S. Cl. 705/37

(57) ABSTRACT

A system, method, apparatus and medium to conduct an auction includes conducting an auction for an item based on a plurality of auction parameters, automatically changing one of the plurality of auction parameters during the auction, and conducting the auction based on at least the changed one of the plurality of auction parameters.

### BACKGROUND OF THE INVENTION

1. Field of the Invention

The present invention relates to auctions. More specifically, the present invention relates to systems for customizing auction parameters.

2. Description of the Related Art

Auctions are popular systems for selling items such as goods and/or services to buyers. In this regard, an auction usually allows a seller to sell an item for a price that is greater than a price for which the item would be sold through conventional retail channels. This price difference results because an item sold through retail channels is usually sold for a single fixed price that is less than some buyers would be willing to pay for the item.

According to a typical auction, an item is presented to prospective buyers and a first bid is submitted by one of the buyers. The first bid includes a first bid price and an agreement to purchase the item for the first bid price. The buyers are notified of the first bid, and if one of the buyers is willing to purchase the item for a second price that is greater than the first bid price, a second bid including the second price may be submitted. It should be noted that a submitted bid including a bid price that is greater than the bid price of any other submitted bid will be referred to as a current bid and the associated bid price will be referred to as a current bid price. Accordingly, the second bid and the second bid price become the current bid and the current bid price, respectively.

Subsequent bids representing increasing bid prices may be accepted until the auction is deemed complete based on some criterion, such as a time limit. At the completion of the auction, the current bid prevails. That is, once the auction is deemed complete, the item is sold for the bid price included in the current bid to the buyer who submitted the current bid.

An auction may be conducted by a seller of an item or by another entity to which the seller provides the right to auction the item. Examples of such an entity include an auction house (e.g. Sotheby's™) or an online auction service (e.g. eBay™). Moreover, an auction may be conducted using any of several known auction methods different from that described above.

Auctions are usually conducted based on particular fixed auction parameters. Auction parameters may include an auction start time, an auction end time, a minimum bid increment, a starting bid price, payment terms, or the like. In order for an auction to efficiently generate a maximum amount of revenue, auction parameters must be assigned appropriate values. For example, a high starting bid price or a high minimum bid increment may discourage the submission of bids and result in a low current bid price at the conclusion of an auction. In addition, too early an auction end time may prevent some buyers from submitting bids which would drive up a current bid price.

In an attempt to address the latter case, some auctions define an auction end time to be at the end of a predefined period of time since a last bid was submitted. Therefore, such an auction ends if a bid is not submitted within the predefined period of time from the last-submitted bid. Although this method provides some flexibility, the method still fails to provide satisfactory control over the auction end time parameter, and provides no control over other auction parameters.

In view of the foregoing, what is needed is an improved system for conducting an auction based on appropriate auction parameters.

### SUMMARY OF THE INVENTION

In order to address the foregoing needs, the present invention provides a system, method, apparatus and medium to conduct an auction. According to one aspect, an auction for an item is conducted based on a plurality of auction parameters, one of the plurality of auction parameters is automatically changed during the auction, and the auction is conducted based on at least the changed one of the plurality of auction parameters. By allowing dynamic modification of auction parameters during an auction, the present invention may ensure that the auction is conducted based on appropriate auction parameters.

In a further aspect of the present invention, it is determined whether a triggering condition has been met and the one of the plurality of auction parameters is changed based on the triggering condition. As a result, the one auction parameter may be assigned a value that is appropriate in view of the occurrence of an event or the existence of a particular situation.

With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a flow diagram of process steps to conduct an auction according to embodiments of the present invention.

FIG. 2 is a topographic view of a network architecture according to embodiments of the present invention.

FIG. 3 is a block diagram of an internal architecture of an auction device according to embodiments to the present invention.

FIG. 4 is a block diagram of an internal architecture of a buyer device according to embodiments to the present invention.

FIG. 5 is a representative view of a tabular portion of an auction database according to embodiments of the present invention.

FIG. 6 is a representative view of a tabular portion of an auction parameter database according to embodiments of the present invention.

FIG. 7 is a flow diagram of process steps to conduct an auction according to embodiments of the present invention.

### DETAILED DESCRIPTION

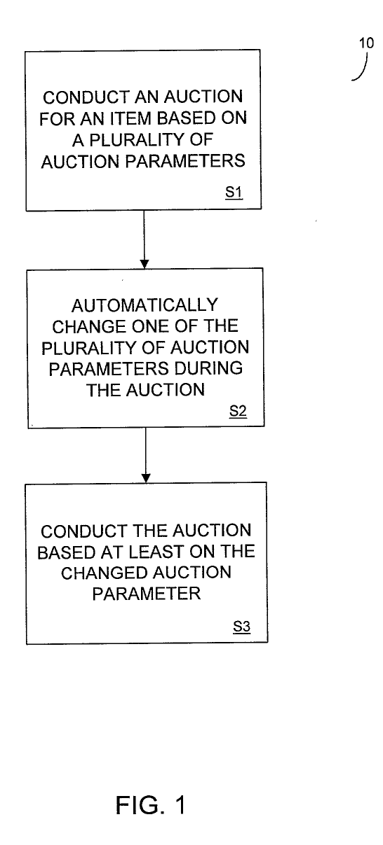

FIG. 1 is a flow diagram of process steps 10 according to embodiments of the invention. Process steps 10 will be described initially below without reference to a specific example in the interest of providing an immediate introduction to features of the present invention. Accordingly, process steps 10 will be described later with respect to a specific example and specific hardware and software embodiments, along with details of alternative embodiments.

Process steps 10 begin at step S1, in which an auction is conducted based on a plurality of auction parameters. The auction conducted in step S1 may be any type of auction, including an auction such as that described in the above Description of the Related Art. As such, the auction may be conducted based on auction parameters including an auction start time, a starting bid price, a “take it” price, a minimum bid increment, and an auction end time.

Next, in step S2, one of the plurality of auction parameters is automatically changed during the auction. The change may be based on a triggering condition which has been met, as will be described in detail below. According to some embodiments, the change of step S2 is intended to improve the efficiency and/or the profitablilty of the conducted auction. For example, rapid bid submission may indicate strong demand for the auctioned item, and therefore the minimum bid increment may be automatically increased in step S2.

Finally, in step S3, the auction is conducted based on at least the changed auction parameter. That is, the auction which was conducted in step S1 continues to be conducted in step S3, albeit based on at least one different auction parameter. As described above, the process steps 10 provide a system to ensure that an auction is conducted based on appropriate auction parameters.

Network Architecture

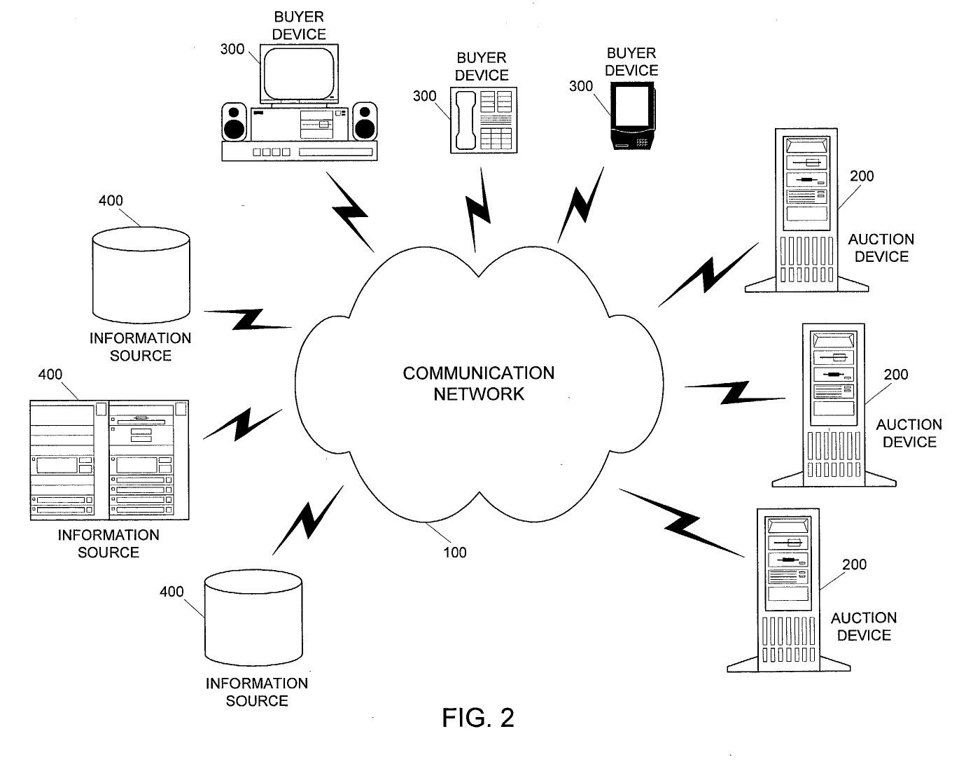

FIG. 2 is a topographic view of a network architecture according to embodiments of the present invention. Of course, many other architectures may be used to implement the invention. Shown in FIG. 2 is communication network 100 in communication with various auction devices 200, buyer devices 300, and information sources 400. It should be noted that the devices shown in communication with communication network 100 need not be constantly exchanging data. Rather, communication may be established when necessary and severed at other times or always available but rarely used to transmit data. In some embodiments, one or more of the FIG. 2 components are in direct communication with one or more of the other components. Moreover, although the illustrated communication links between the components of FIG. 2 and communication network 100 appear dedicated, it should be noted that each of the links may be shared by other components.

Communication network 100 may comprise any number of systems for transferring data, including a local area network, a wide area network, a telephone network, a cellular network, a fiber-optic network, a satellite network, an infra-red network, a radio frequency network, and any other type of network which may be used to transmit information between devices. Additionally, communication network 100 may be used to transmit data using any known transmission protocol, such as Asynchronous Transfer Mode (ATM), Internet Protocol (IP), Hypertext Transfer Protocol (HTTP) and Wireless Application Protocol (WAP).

Auction devices 200 as depicted in FIG. 2 and described herein are dedicated World Wide Web servers. As will be understood, other devices may be used as auction devices 200 in accordance with the present invention, including mainframe computers, workstations, kiosks, networks, other devices, and any combination thereof.

Auction devices 200 may be used to execute process steps 10 according to the present invention. Generally, auction devices 200 may be used to present items being auctioned to a buyer spontaneously or in response to a request from the buyer, to present auction rules and other administrative information to the buyer, to conduct an auction based on a plurality of auction parameters, to accept submitted bids from the buyer, to detect triggering conditions, to automatically change an auction parameter, to conduct an auction based at least on the changed auction parameter, to determine the buyer to whom the item should be sold at the conclusion of an auction, and to settle the purchase of the item between the determined buyer, the auctioning entity, and the seller, if different from the auctioning entity.

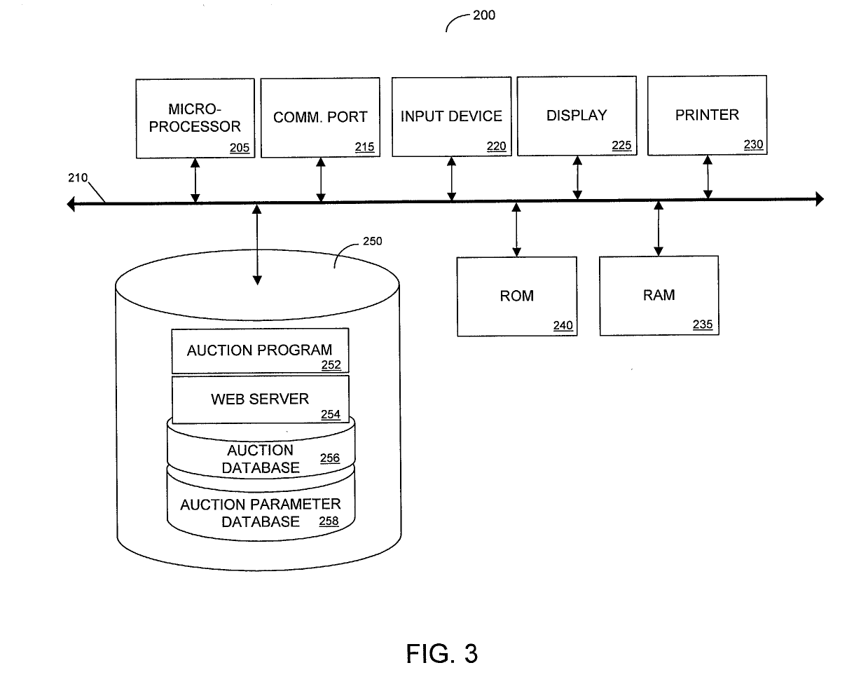

One or more of auction devices 200 may be operated by an entity such as an auction house, an online auction service, and a private seller to conduct one or more simultaneous auctions. Accordingly, one auction device 200 may be operated by a single auctioning entity to conduct one or more simultaneous auctions. Further details of one auction device 200 according to embodiments of the invention are set forth below with respect to FIG. 3.

Buyer devices 300 of FIG. 2 comprise a workstation, a telephone and a personal digital assistant. Buyer devices 300 are used to communicate with auction devices 200 in order to obtain auctioned items. In this regard, buyer devices 300 usable in conjunction with the present invention include any device capable of presenting information to a buyer, visually and/or aurally, and of transmitting an indication made by the buyer to an external device. Of course, buyer devices 300 should be able to communicate with the device or devices with which they are in communication over whatever type of network media exist between the devices.

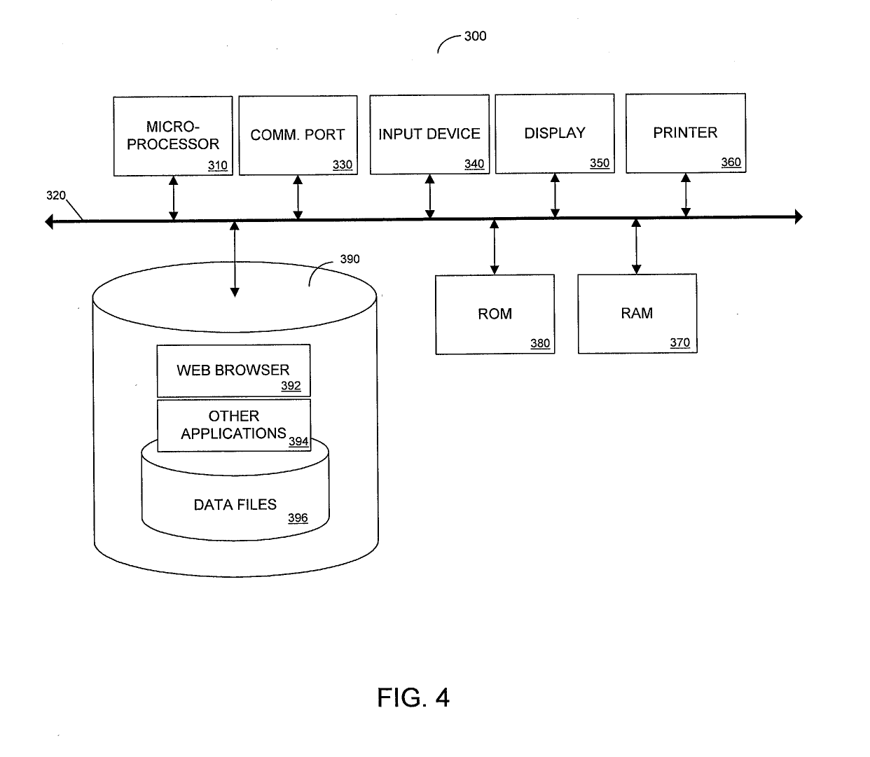

Each of buyer devices 300 may be operated by a buyer to access one or more auctions conducted by one or more of auction devices 200, to receive information regarding items being auctioned, to submit bids to one or more auctions, and to pay for an item for which a submitted bid prevails. Details of one embodiment of a buyer device 300 are set forth below with respect to FIG. 4.

An auction device 200 receives information from information sources 400 before, while and after conducting an auction. The information may be used to determine whether to automatically change an auction parameter based on which the auction is conducted. More specifically, the information may be used to determine if a triggering condition has been met. Information sources 400 may include a mainframe computer, databases, or any other components or group of components capable of transmitting information. Specific examples of information sources 400 include a brokerage house mainframe computer, a product inventory database, a weather-forecasting website, a repository of historical auction data and statistics, and a news service transmission link.

Auction Device

FIG. 3 is a block diagram of the internal architecture of an auction device 200 according to one embodiment of the invention. As illustrated, auction device 200 includes microprocessor 205 in communication with communication bus 210. Microprocessor 205 may be a Pentium™, RISC™-based, or other type of processor and is used to execute processor-executable process steps so as to control the components of auction device 200 to provide functionality according to embodiments of the present invention.

Also in communication with communication bus 210 is communication port 215. Communication port 215 is used to transmit data to and to receive data from external devices. Communication port 215 is therefore preferably configured with hardware suitable to physically interface with desired external devices and/or network connections. In one embodiment, information regarding triggering conditions, bidding and other auction information is transmitted to and bids are received from information sources 400 and buyer devices 300 over communication port 215.

Input device 220, display 225 and printer 230 are also in communication with communication bus 210. Any known input device may be used as input device 220, including a keyboard, mouse, touch pad, voice-recognition system, or any combination of these devices. Input device 220 may be used by an auctioning entity operating auction device 200 to input information regarding items to be auctioned, such as a description and a starting bid price. Input device 220 may also be used to assign values to auction parameters and/or to define how auction parameters may be changed in response to particular triggering conditions. Of course, such information may also be input to auction device 200 via communication port 215. Commands for controlling operation of auction device 200 may also be input using input device 220, such as commands to begin conducting an auction, to stop conducting an auction, and to output a report detailing auction statistics.

Such a report may be output to display 225, which may be an integral or separate CRT display, flat-panel display or the like. Display 225 is generally used to output graphics and text to an operator in response to commands issued by microprocessor 205. Printer 230 may also output graphics and text, but in hardcopy form using ink-jet, thermal, dot-matrix, laser, or other printing technologies.

RAM 235 is connected to communication bus 210 to provide microprocessor 205 with fast data storage and retrieval. In this regard, processor-executable process steps being executed by microprocessor 205 are typically stored temporarily in RAM 235 and executed therefrom by microprocessor 205. ROM 240, in contrast, provides storage from which data can be retrieved but to which data cannot be stored. Accordingly, ROM 240 is used to store invariant process steps and other data, such as basic input/output instructions and data used during system boot-up or to control communication port 215. It should be noted that one or both of RAM 235 and ROM 240 may communicate directly with microprocessor 205 instead of over communication bus 210.

Data storage device 250 stores, among other data, auction program 252 of processor-executable process steps. Microprocessor 205 executes process steps of auction program 252 in order to control auction device 200 to conduct one or more auctions in accordance with the present invention. For example, the process steps may include process steps 10 of FIG. 1. More specifically, the process steps of auction program 252 may be executed by microprocessor 205 to conduct an auction for an item based on a plurality of auction parameters, to automatically change one of the plurality of auction parameters during the auction, and to conduct the auction based on at least the changed one of the plurality of auction parameters. Such steps advantageously provide an ability to ensure that the auction is conducted based on appropriate auction parameters.

The process steps of auction program 252 may also be executed to determine whether a triggering condition has been met and to automatically change the one of the plurality of auction parameters based on the triggering condition. As a result, the one auction parameter may be assigned a value that is appropriate in view of the occurrence of an event or the existence of a particular situation. Moreover, auction program 252 may include process steps of an interactive voice response system enabling auction device 200 to transmit inquiries to and receive responses from a buyer using a telephone buyer device 300.

The process steps of auction program 252 may be read from a computer-readable medium, such as a floppy disk, a CD-ROM, a DVD-ROM, a Zip™ disk, a magnetic tape, or a signal encoding the process steps, and then stored in data storage device 250 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

Also stored in data storage device 250 are processor-executable process steps of Web server 254. Web server 254 allows auction device 200 to communicate with buyer devices 300 and information sources 400 over the World Wide Web. In this regard, auction device 200 may also comprise a Web client (not shown) to access information from a Web server executed by information source 400.

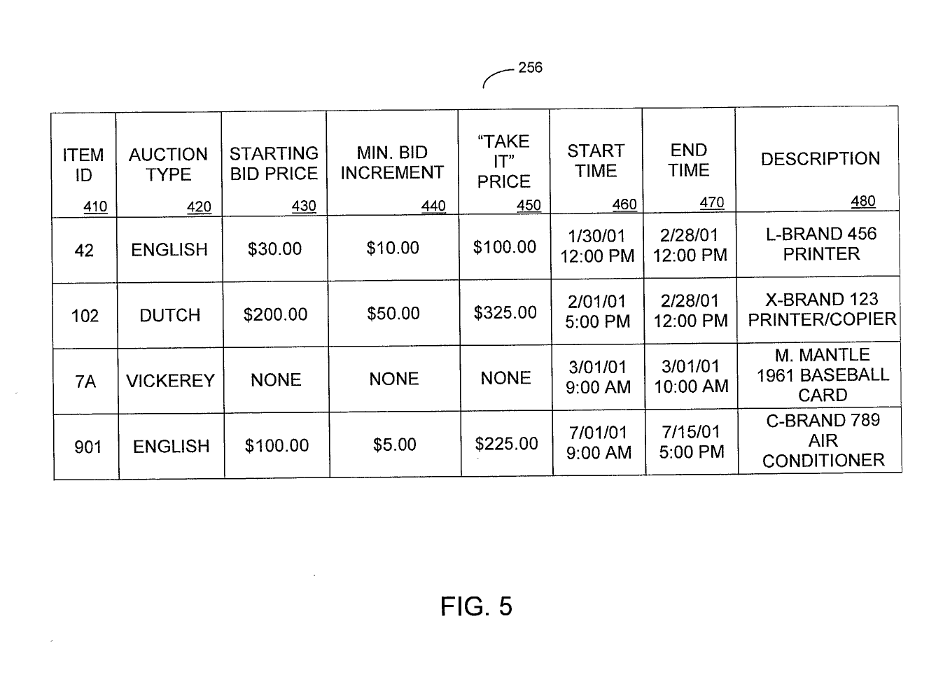

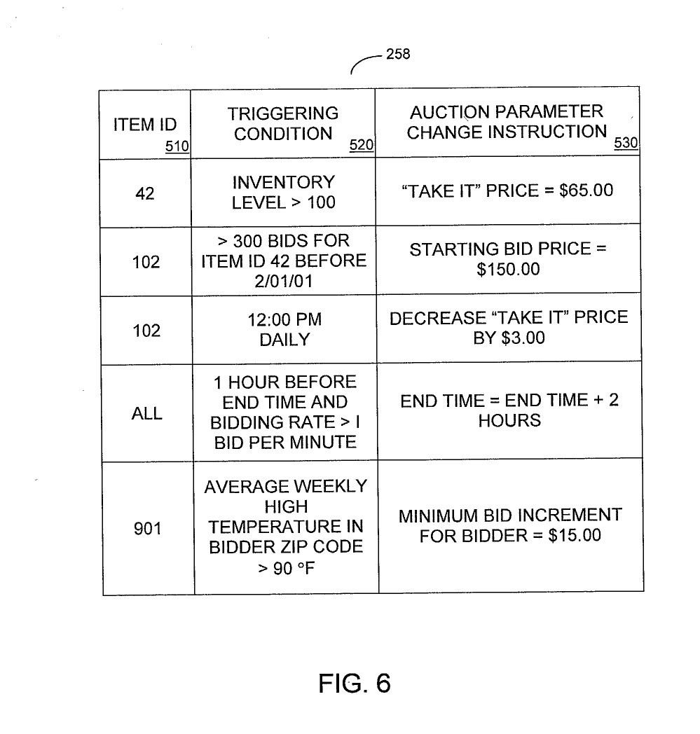

Data storage device 250 also stores auction database 256 and auction parameter database 258. Auction database 256 and auction parameter database 258 include information usable in conjunction with auction program 252 to conduct an auction in accordance with the present invention. The information stored in auction database 256 and auction parameter database 258 and its use will be discussed in detail below with reference to FIG. 5 and FIG. 6, respectively.

Stored in data storage device 250 may also be other unshown elements that may be necessary for operation of auction device 200, such as other applications, other data files, an operating system, a database management system and “device drivers” for allowing microprocessor 205 to interface with devices in communication with communication port 215. These elements are known to those skilled in the art, and are therefore not described in detail herein.

Buyer Device

FIG. 4 is a block diagram illustrating an internal architecture of one type of buyer device 300. Buyer device 300 according to the depicted embodiment includes microprocessor 310, communication port 330, input device 340, display 350, printer 360, RAM 370 and ROM 380, each of which is in communication with communication bus 320. Possible embodiments of each of these components are similar to those described with respect to identically-named components of FIG. 3, although functions performed by the components of FIG. 4 according to the invention may differ from those performed by the components of FIG. 3.

Specifically, communication port 330 may be used to receive auction information from auction device 200 and to transmit a bid to auction device 200, and input device 340 may be used to input a buyer selection of a desired item and details of a bid for the item. Moreover, display 350 and printer 360 may be used to present a picture of an item being auctioned, a description of the item, a starting bid price for the item, a minimum bid increment and other auction information to a buyer.

Also in communication with communication bus 320 is buyer storage device 390, which, as shown, stores processor-executable process steps of Web browser 392 and other applications 394 as well as data files 396. The process steps of Web browser 392 may be executed by microprocessor 310 to transmit and receive information to and from the World Wide Web and, in particular, to and from Web server 254 of auction device 200. Other applications 394 and data files 396 may respectively include processor-executable process steps and data for other applications, device drivers, and an operating system for controlling base processes of buyer device 300.

Auction Database

A tabular representation of a portion of auction database 256 is shown in FIG. 5. As shown, auction database 256 includes several records and associated fields. It is contemplated that auction database 256 may include many more records than those shown and that each record may include fields other than those illustrated.

The fields of FIG. 5 specify item ID 410 and auction parameters associated with item ID 410. Item ID 410 identifies an item to be auctioned by auction device 200, and the associated auction parameters define values based on which the auction will be conducted. The auction parameters of the FIG. 5 embodiment include auction type 420, starting bid price 430, minimum bid increment 440, “take it” price 450, start time 460, end time 470 and description 480.

Auction type 420 specifies the type of auction that will be conducted for the item associated with item ID 410. Many auction types 420 may be used in conjunction with the present invention, including an English auction, a Dutch auction, a single-sided auction, a double-sided auction, a single-quantity auction, a multiple-quantity auction, a first price auction, a Vickerey auction, a multi-attribute auction, a sell-side auction, and a buy-side auction.

Starting bid price 430 specifies a bid price at which bidding for the associated item will begin. Accordingly, starting bid price 430 may reflect a lowest price for which a seller is willing to sell the item. All bids submitted for the item must therefore include bid prices greater than or equal to starting bid price 430. As shown, a seller or auctioning entity may choose not to associate a starting bid price 430 with an item ID 410.

Minimum bid increment 440 indicates a minimum amount by which the bid price of a submitted bid must exceed a current bid price in order for the submitted bid to be accepted. For example, in the case of the first record shown in FIG. 5, a first bid for item ID 410 “42” may include a bid price of $30.00. A next bid will be accepted only if the next bid includes a bid price of at least $30.00+$10.00=$40.00, since the associated minimum bid increment 440 is equal to $10.00. A minimum bid increment 440 may be expressed as a fixed amount, a percentage of a current bid price, or in some other manner. An item may also be associated with no minimum bid increment 440 or, in the case of a seller-side auction, a negative-valued bid increment 440.

“Take it” price 450 specifies a price for which the associated item may be purchased (or sold, in the case of a seller-side auction) during an auction for the item. Accordingly, a buyer may submit a bid to the auction and wait to see if the bid prevails or may simply indicate an agreement to purchase the item for associated “take it” price 450. In this regard, “take it” price 450 is similar to a retail price for the item.

Start time 460 and end time 470 define a period during which an auction for an associated item will be active. More specifically, start time 460 and end time 470 specify a timeframe during which bids for the associated item will be accepted. As shown in FIG. 5, auction database 256 may be used to manage auctions having overlapping or mutually-exclusive active periods.

Description 480 includes a description of an associated item. Description 480 may be presented to prospective buyers so that the buyers can determine whether they would like to submit bids for the associated item. Accordingly, description 480 may contain as much or as little detail regarding the item as believed appropriate. Description 480 may include a photograph of the item or means for obtaining further information regarding the item, such as a hyperlink.

In the illustrated portion of auction database 256, each record contains information associated with items being auctioned in a single auction marketplace. For example, the records shown in FIG. 5 may describe items currently being auctioned on the eBay™ website. Auction database 256 may also store information for items being auctioned by several auction marketplaces. In this regard, an item represented in auction database 256 may be auctioned in several marketplaces by several auctioning entities, simultaneously or otherwise. In contrast, some items represented in auction database 256 may be auctioned in only one auction marketplace, with other represented items being auctioned in another auction marketplace.

Auction Parameter Database

FIG. 6 shows a tabular representation of a portion of auction parameter database 258 according to embodiments of the invention. The data stored in auction parameter database 258 may be used in accordance with the invention to automatically change an auction parameter during an auction. Of course, data structures or methods other than those described herein may be used to automatically change an auction parameter during an auction in accordance with the invention.

Each record in the tabular portion of auction parameter database 258 includes fields specifying an item ID 510, a triggering condition 520 and an auction parameter change instruction 530. In the illustrated example, item ID 510 represents an item represented in auction database 256 by an identical item ID 410. A triggering condition 520 associated with an item ID 510 defines a condition that, if met, will result in an auction parameter changing as indicated by an associated auction parameter change instruction 530. For example, auction device 200 may conduct an auction for an item having a particular item ID 410 based on auction parameters associated with the item ID 410 in auction database 256. If, during the auction, a triggering condition 520 associated with the identical item ID 510 is determined to have been met, an auction parameter is automatically changed based on auction parameter change instruction 530 associated with the met triggering condition 520. Accordingly, the auction is thereafter conducted based on the changed auction parameter.

As shown in FIG. 6, triggering condition 520 associated with an item ID 510 may relate to an inventory level of the associated item, a number of bids submitted, a time of day, a time until auction end time, a bidding rate, a weather condition, and a combination of any number of the foregoing. Of course, triggering condition 520 may be based on any number of other factors, including recent bidding histories of all buyers, of all sellers, of an individual buyer or of a set of buyers. Triggering condition 520 may also be based on bidding histories for items similar to the associated item, bidding histories for items complementary to the associated item, and bidding histories for items substitutable for the associated item.

Also considered in triggering condition 520 may be transaction histories of a particular buyer, seller, or set of buyers or sellers, demographics or profiles of a particular buyer, seller, or set of buyers or sellers, and psychographics of a particular buyer, seller or set of buyers or sellers. Furthermore, triggering condition 520 may be based on news events, sporting results, analysts' reports, timing of marketing and promotional campaigns for the associated item or related items, and supply chain information such as production capacity, projected demand and inventory levels.

As also shown in FIG. 6, auction parameter change instruction 530 may include instructions to change any auction parameter based on which an auction is conducted. The changed auction parameter may apply to all buyers participating in the auction or to only a subset of buyers, as in the case of the auction parameter changed by auction parameter change instruction 530 associated with item ID 510 “901”. In addition to those auction parameters shown in FIG. 5 and FIG. 6, auction parameters which may be automatically changed according to the present invention include transaction fees, item delivery terms, payment terms, definitions of allowable buyers, definitions of excluded buyers, a number of units being auctioned as a single item, and incentives for submitting bids through specified communications channels.

It should be noted that a single item ID 510 may be associated with more than one triggering condition 520 and auction parameter change instruction 530. Moreover, a triggering condition 520 and auction change instruction 530 may be associated with “ALL” item ID 510. In such a case, the associated triggering condition 520 and auction change instruction 530 are applicable to all auctions conducted by auction device 200.

The tabular illustrations and accompanying descriptions of auction database 256 and auction parameter database 258 merely represent relationships between stored information. A number of other arrangements may be employed besides those suggested by the tables shown. Similarly, the illustrated entries of the databases represent sample information only; those skilled in the art will understand that the number and content of the entries can be different from those illustrated.

Specific Example

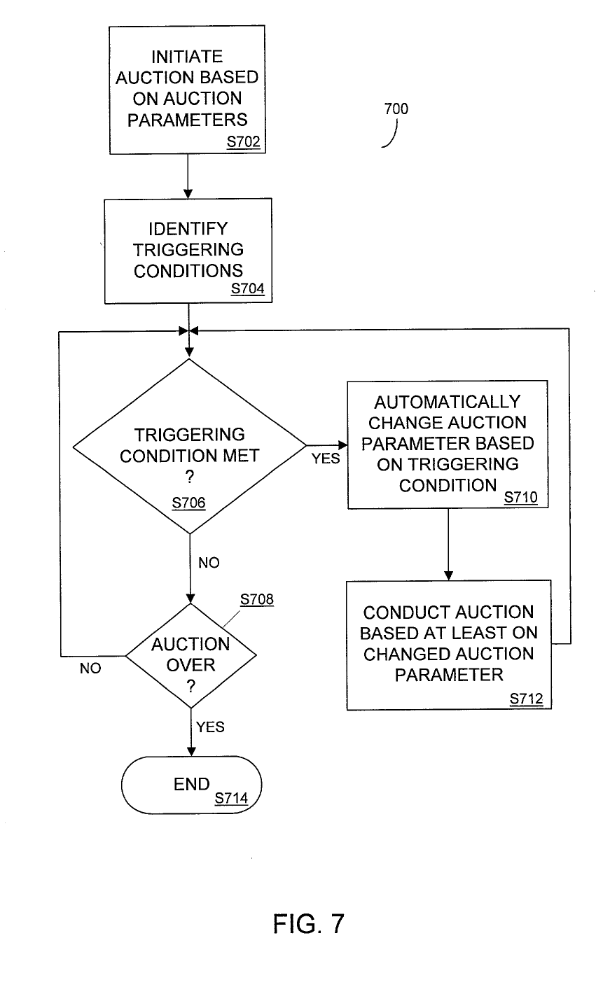

Process steps 700 of FIG. 7 set forth a process to conduct an auction according to embodiments of the present invention. Briefly, according to process steps 700, an auction for an item is conducted based on a plurality of auction parameters, one of the plurality of auction parameters is automatically changed during the auction, and the auction is conducted based on at least the changed one of the plurality of auction parameters. As described above, these features advantageously provide an ability to ensure that the auction is conducted based on appropriate auction parameters.

Flow begins at step S702, in which an auction is initiated based on auction parameters. In one embodiment of step S702, an item ID 410 corresponding to an item to be auctioned is identified and an auction for the item is initiated based on auction parameters 420 through 480 associated with the item ID 410. Many other systems to initiate an auction based on a plurality of auction parameters may be used in accordance with the present invention.

After step S702, triggering conditions associated with the initiated auction are identified in step S704. In the present example, the triggering conditions are identified by locating triggering conditions 520 stored in auction information database 258 which are associated with the item ID 510 of the item being auctioned. Of course, any triggering conditions 520 associated with the item ID 510 “ALL” are identified in step S704.

After identification of the triggering conditions, it is determined in step S706 whether any of the identified triggering conditions have been met. Depending on the identified triggering conditions, such determination may require auction device 200 to request and receive information from one or more of information sources 400 or from other devices. It should be noted that the auction initiated in step S702 continues to be conducted during steps S704 and S706 according to the present embodiment.

If it is determined that a triggering condition has been met, flow proceeds from step S706 to step S710 to automatically change an auction parameter based on the met triggering condition. An auction parameter may be automatically changed by identifying auction parameter change instruction 530 associated with the met triggering condition 520 in auction parameter database 258 and changing an auction parameter according to the identified change instruction 530.

After step S710, the auction initiated in step S702 is conducted based at least on the changed auction parameter in step S712. That is, the auction continues to be conducted, albeit based on the changed auction parameter. For example, in a case that a minimum bid increment was increased from an original minimum bid increment in step S710, the auction continues in step S712 based on the increased minimum bid increment. As a result, any submitted bid including a bid price that is different from a current bid price by an amount equal to the original minimum bid increment will not be accepted. While the auction continues, flow returns from step S712 back to step S706 to again determine whether a triggering condition has been met.

If it is determined in step S706 that no triggering condition has been met, it is determined in step S708 whether the auction is over. In one embodiment, the auctioned is determined to be over if a current time is equal to an end time 470 associated with the auction in auction database 256. If the auction is not deemed over, flow returns to step S706. Accordingly, flow cycles through steps S706 and S708 until it is determined in step S708 that the auction is over. Once it is determined that the auction is over, flow proceeds to step S714 and terminates therein.

Process steps 10, process steps 700 and the other process steps set forth herein are described as being performed by auction device 200 through execution of processor-executable process steps of auction program 252 by microprocessor 205. However, the process steps may also be performed, in whole or in part, by one or more of buyer devices 300, other auction devices 200, other devices, and manual means.

In one alternative example, a seller of an item uses a seller device to submit item information and auction parameters to an auctioning entity operating auction device 200. Accordingly, the auctioning entity operates auction device 200 to conduct an auction for the item based on the submitted auction parameters. Next, the seller operates the seller device to automatically change one of the auction parameters and to submit the changed auction parameter to auction device 200. Thereafter, auction device 200 conducts the auction based on at least the changed auction parameter.

Although the present invention has been described with respect to particular embodiments thereof, those skilled in the art will note that various substitutions may be made to those embodiments described herein without departing from the spirit and scope of the present invention.

What is claimed is:

1. A method for conducting an auction, comprising:
conducting an auction for an item based on a plurality of auction parameters;
automatically changing one of the plurality of auction parameters during the auction; and
conducting the auction based on at least the changed one of the plurality of auction parameters.

2. A method according to claim 1, further comprising:
determining if a triggering condition has been met,
wherein the one of the plurality of auction parameters is changed based on the triggering condition.

3. A method according to claim 1, wherein the plurality of auction parameters comprise one or more of a starting bid price, a “take it” price, a minimum bidding increment, an auction type, a transaction fee, payment terms, delivery terms, a description of the item, a definition of allowable counterparties, and a definition of excluded counterparties.

4. A method according to claim 1, wherein the one of the plurality of auction parameters is changed based on at least one of group bidding history and individual bidding history

5. A method according to claim 1, wherein the one of the plurality of auction parameters is changed based on at least one of a bidding history for an item similar to the item, a bidding history for items complementary to the item, and a bidding history for items substitutable for the item.

6. A method according to claim 1, wherein the one of the plurality of auction parameters is changed based on supply chain information including one or more of production capacity, projected demand and inventory levels.

7. A method according to claim 1, wherein the one of the plurality of auction parameters is changed based on a bidding rate.

8. A method according to claim 1, wherein the one of the plurality of auction parameters is changed based on an elapsed time of the auction.

9. A method according to claim 1, wherein the one of the plurality of auction parameters is changed based on a rate of change of submitted bid prices.

10. A method according to claim 1, wherein the one of the plurality of auction parameters is changed based on weather conditions.

11. A method according to claim 1, wherein the one of the plurality of auction parameters is changed based on a timing of a marketing campaign for the item.

12. A method according to claim 1, wherein the one of the plurality of auction parameters is changed for all buyers.

13. A method according to claim 1, wherein the one of the plurality of auction parameters is changed for less than all buyers.

14. A method according to claim 1, wherein the one of the plurality of auction parameters is changed at predetermined time intervals.

15. A method according to claim 1, wherein the one of the plurality of auction parameters is changed based on buyer demographic information.

16. A method according to claim 1, wherein the one of the plurality of auction parameters is changed based on buyer profile information.

17. An apparatus, comprising:
a processor; and
a storage device in communication with said processor and storing instructions adapted to be executed by said processor to:
conduct an auction for an item based on a plurality of auction parameters;
automatically change one of the plurality of auction parameters during the auction; and
conduct the auction based on at least the changed one of the plurality of auction parameters.

18. An apparatus according to claim 17, wherein the stored instructions adapted to be executed by said processor further comprise instructions adapted to be executed by said processor to:
determine if a triggering condition has been met,
wherein the one of the plurality of auction parameters is changed based on the triggering condition.

19. An apparatus according to claim 17, wherein the plurality of auction parameters comprise one or more of a starting bid price, a “take it” price, a minimum bidding increment, an auction type, a transaction fee, payment terms, delivery terms, a description of the item, a definition of allowable counterparties, and a definition of excluded counterparties.

20. An apparatus according to claim 17, wherein the one of the plurality of auction parameters is changed based on at least one of group bidding history and individual bidding history.

21. An apparatus according to claim 17, wherein the one of the plurality of auction parameters is changed based on at least one of a bidding history for an item similar to the item, a bidding history for items complementary to the item, and a bidding history for items substitutable for the item.

22. An apparatus according to claim 17, wherein the one of the plurality of auction parameters is changed based on supply chain information including one or more of production capacity, projected demand and inventory levels.

23. An apparatus according to claim 17, wherein the one of the plurality of auction parameters is changed based on a bidding rate.

24. An apparatus according to claim 17, wherein the one of the plurality of auction parameters is changed based on an elapsed time of the auction.

25. An apparatus according to claim 17, wherein the one of the plurality of auction parameters is changed based on a rate of change of submitted bid prices.

26. An apparatus according to claim 17, wherein the one of the plurality of auction parameters is changed based on weather conditions.

27. An apparatus according to claim 17, wherein the one of the plurality of auction parameters is changed based on a timing of a marketing campaign for the item.

28. An apparatus according to claim 17, wherein the one of the plurality of auction parameters is changed for all buyers.

29. An apparatus according to claim 17, wherein the one of the plurality of auction parameters is changed for less than all buyers.

30. An apparatus according to claim 17, wherein the one of the plurality of auction parameters is changed at predetermined time intervals.

31. An apparatus according to claim 17, wherein the one of the plurality of auction parameters is changed based on buyer demographic information.

32. An apparatus according to claim 17, wherein the one of the plurality of auction parameters is changed based on buyer profile information.

33. A medium storing processor-executable process steps to conduct an auction, the process steps comprising:
a step to conduct an auction for an item based on a plurality of auction parameters;
a step to automatically change one of the plurality of auction parameters during the auction; and
a step to conduct the auction based on at least the changed one of the plurality of auction parameters.

34. A medium according to claim 33, the process steps further comprising:
a step to determine if a triggering condition has been met,
wherein the one of the plurality of auction parameters is changed based on the triggering condition.

35. A medium according to claim 33, wherein the plurality of auction parameters comprise one or more of a starting bid price, a “take it” price, a minimum bidding increment, an auction type, a transaction fee, payment terms, delivery terms, a description of the item, a definition of allowable counterparties, and a definition of excluded counterparties.

36. A medium according to claim 33, wherein the one of the plurality of auction parameters is changed based on at least one of group bidding history and individual bidding history.

37. A medium according to claim 33, wherein the one of the plurality of auction parameters is changed based on at least one of a bidding history for an item similar to the item, a bidding history for items complementary to the item, and a bidding history for items substitutable for the item.

38. A medium according to claim 33, wherein the one of the plurality of auction parameters is changed based on supply chain information including one or more of production capacity, projected demand and inventory levels.

39. A medium according to claim 33, wherein the one of the plurality of auction parameters is changed based on a bidding rate.

40. A medium according to claim 33, wherein the one of the plurality of auction parameters is changed based on an elapsed time of the auction.

41. A medium according to claim 33, wherein the one of the plurality of auction parameters is changed based on a rate of change of submitted bid prices.

42. A medium according to claim 33, wherein the one of the plurality of auction parameters is changed based on weather conditions.

43. A medium according to claim 33, wherein the one of the plurality of auction parameters is changed based on a timing of a marketing campaign for the item.

44. A medium according to claim 33, wherein the one of the plurality of auction parameters is changed for all buyers.

45. A medium according to claim 33, wherein the one of the plurality of auction parameters is changed for less than all buyers.

46. A medium according to claim 33, wherein the one of the plurality of auction parameters is changed at predetermined time intervals.

47. A medium according to claim 33, wherein the one of the plurality of auction parameters is changed based on buyer demographic information.

48. A medium according to claim 33, wherein the one of the plurality of auction parameters is changed based on buyer profile information.
